(19) United States
(12) Patent Application Publication
(10) Pub. No.: US 2024/0024756 A1
(43) Pub. Date: Jan. 25, 2024

(54) LEARNING DEVICE, ESTIMATION DEVICE, LEARNING METHOD, AND LEARNING PROGRAM

(71) Applicant: NIPPON TELEGRAPH AND TELEPHONE CORPORATION, Tokyo (JP)

(72) Inventors: Takasuke NAGAI, Musashino-shi, Tokyo (JP); Shoichiro TAKEDA, Musashino-shi, Tokyo (JP); Shinya SHIMIZU, Musashino-shi, Tokyo (JP)

(73) Assignee: NIPPON TELEGRAPH AND TELEPHONE CORPORATION, Tokyo (JP)

(21) Appl. No.: 18/023,859

(22) PCT Filed: Sep. 3, 2020
(86) PCT No.: PCT/JP2020/033425

§ 371 Date: Feb. 28, 2023

(51) Int. Cl. A63B 71/06; G06T 5/00

(52) U.S. Cl. CPC A63B 71/0669; G06T 5/005; G06T 2207/10024; G06T 2207/20081

(57) ABSTRACT

Learning model data indicating a relationship between mask video data obtained by arbitrarily masking a part of a region surrounding a player in each of a plurality of image frames included in video data in which actions of the player are recorded, and a mask score obtained by weighting a true value score which is an evaluation value for a game of the player recorded in the video data according to a ratio of the masked region is generated.

### TECHNICAL FIELD

The present invention relates to a learning device, a learning method, and a learning program for learning, for example, know-how related to a method of scoring a game of a player, and an estimation device for estimating a score of a game on the basis of a learning result.

### BACKGROUND ART

Among sports games, there are games in which an official referee grades a score for a game played by a player, such as a high dive, figure skating, and gymnastics, and determines the ranking of each game on the basis of the graded score. In scoring of such a game, there are quantitative scoring criteria.

In recent years, studies have been made on technology used for evaluating activity quality in the field of computer vision, such as automatic estimation of scores in such a game, and as such technology, technology called Action Quality Assessment (AQA) is known.

For example, the technology described in NPL 1 proposes a method of estimating a score by extracting features from video data in which a series of actions performed by a player is recorded by deep learning using the video data as input data.

FIG. 10 is a block diagram showing a schematic configuration of a learning device 100 and an estimation device 200 in the technology described in NPL 1. A learning processing unit 101 of the learning device 100 is provided with, as learning data, video data in which a series of actions performed by a player is recorded, and a true value score t_{score} graded by a referee for the game of the player. The learning processing unit 101 includes a deep neural network (DNN) and applies coefficients such as weights and biases stored in a learning model data storage unit 102 to the DNN.

The learning processing unit 101 calculates a loss L_{SR} using an estimated score y_{score} obtained as an output value by providing the video data to the DNN and the true value score t_{score} corresponding to the video data. The learning processing unit 101 calculates new coefficients to be applied to the DNN by an error back propagation method such that the calculated loss L_{SR} is reduced. The learning processing unit 101 updates the coefficients by writing the calculated new coefficients in the learning model data storage unit 102.

By repeating processing of updating such coefficients, coefficients gradually converge, and coefficients that finally converge are stored in the learning model data storage unit 102 as learning model data indicating a trained learning model. In NPL 1, a loss function such as L_{SR}=L1 distance (y_{score} t_{score})+L2 distance (Y_{score}, t_{score}) is used to calculate the loss L_{SR}.

The estimation device 200 includes an estimation processing unit 201 including a DNN having the same configuration as that of the learning processing unit 101, and a learning model data storage unit 202 that preliminarily stores trained learning model data stored in the learning model data storage unit 102 of the learning device 100. Trained learning model data stored in a learning model data storage unit 202 is applied to the DNN of the estimation processing unit 201. The estimation processing unit 201 provides video data in which a series of actions performed by an arbitrary player are recorded to the DNN as input data, and thereby obtains an estimated score y_{score} for the corresponding game as an output value of the DNN.

### CITATION LIST

### Non Patent Literature

[NPL 1] Paritosh Parmar and Brendan Tran Morris, “Learning To Score Olympic Events,” in CVPR Workshop. 2017

### SUMMARY OF INVENTION

### Technical Problem

The following experiments were attempted for the technology described in NPL 1. Video data in which a series of actions performed by a player shown in FIG. 11(a) is recorded (hereinafter referred to as “original video data”), and video data in which a region where the player is displayed in each of a plurality of image frames included in the original image data is surrounded by rectangular regions 301, 302, and 303 and the rectangular regions are painted in an average color (hereinafter referred to as “player-concealed video data”) of the image frames, shown in FIG. 11(b) are prepared. Although the ranges of the regions 301, 302, and 303 are represented by dotted-line frames, these dotted-line frames are represented to clarify the ranges and do not exist in the actual player-concealed video data.

As shown in FIG. 11(a), a degree of accuracy of an estimated score y_{score} obtained when the original video data has been provided to the estimation processing unit 201 is “0.8890.” On the other hand, as shown in FIG. 11(b), a degree of accuracy of an estimated score y_{score} obtained when the player-concealed video data has been provided to the estimation processing unit 201 is “0.8563.” From these experimental results, it can be ascertained that, when the player-concealed video data has been provided to the estimation processing unit 201, a score is estimated with high accuracy although actions of the player are invisible, and score estimation accuracy is hardly lowered as compared with the case of the original video data in which the actions of the player are visible.

In the technology described in NPL 1, only video data is provided as learning data without explicitly providing features related to actions of the player, for example, joint coordinates and the like. Therefore, from the above experimental results, features in the video which are not related to the actions of the player, for example, features of the background such as a hall, are extracted, and it is presumed that learning model data may not be generalized to the actions of the player in the technology described in NPL 1. Since the features of the background such as a hall are extracted, it is also presumed that the technology described in NPL 1 may deteriorate accuracy with respect to video data including an unknown background.

Although there is also a method of explicitly providing joint information such as human joint coordinates, joints perform complicated actions and thus it is difficult to estimate the joints, and inaccurate joint information adversely affects accuracy. Therefore, there is a problem that a method of explicitly providing joint information should be avoided.

In view of the above-mentioned circumstances, an object of the present invention is to provide technology capable of generating learning model data generalized to actions of a player from video data in which the actions of the player are recorded without explicitly providing information that is difficult to estimate, such as joint information.

### Solution to Problem

One aspect of the present invention is a learning device including a learning processing unit configured to generate learning model data indicating a relationship between mask video data obtained by arbitrarily masking a part of a region surrounding a player in each of a plurality of image frames included in video data in which actions of the player are recorded, and a mask score obtained by weighting a true value score which is an evaluation value for a game of the player recorded in the video data according to a ratio of the masked region.

One aspect of the present invention is an estimation device including: an input unit configured to fetch video data in which actions of a player are recorded; and an estimation processing unit configured to calculate an estimated score corresponding to the video data on the basis of learning model data indicating a relationship between mask video data obtained by arbitrarily masking a part of a region surrounding the player in each of a plurality of image frames included in the video data in which actions of the player are recorded and a mask score obtained by weighting a true value score which is an evaluation value for a game of the player recorded in the video data according to a ratio of the masked region, and the video data.

One aspect of the present invention is a learning method including generating learning model data indicating a relationship between mask video data obtained by arbitrarily masking a part of a region surrounding a player in each of a plurality of image frames included in video data in which actions of the player are recorded, and a mask score obtained by weighting a true value score which is an evaluation value for a game of the player recorded in the video data according to a ratio of the masked region.

One aspect of the present invention is a learning program for causing a computer to execute a procedure of generating learning model data indicating a relationship between mask video data obtained by arbitrarily masking a part of a region surrounding a player in each of a plurality of image frames included in video data in which actions of the player are recorded, and a mask score obtained by weighting a true value score which is an evaluation value for a game of the player recorded in the video data according to a ratio of the masked region.

### Advantageous Effects of Invention

According to the present invention, it is possible to generate learning model data generalized to actions of a player from video data in which the actions of the player are recorded without explicitly providing information that is difficult to estimate, such as joint information.

### BRIEF DESCRIPTION OF DRAWINGS

FIG. 1 is a block diagram showing a configuration of a learning device according to an embodiment of the present invention.

FIG. 2 is a diagram showing an example of an image frame in the present embodiment.

FIG. 3 is a flowchart showing a flow of processing of a learning data generation unit of the present embodiment.

FIG. 4 is a diagram showing a relationship between an image frame and a region indicated by player region specifying data and a mask region in the present embodiment.

FIG. 5 is a diagram showing a state in which mask processing has been performed on a mask region of an image frame in the present embodiment.

FIG. 6 is a flowchart showing a flow of processing of a learning processing unit of the present embodiment.

FIG. 7 is a diagram showing an example of a function approximater included in the learning processing unit of the present embodiment and data provided to the function approximater.

FIG. 8 is a block diagram showing a configuration of an estimation device of the present embodiment.

FIG. 9 is a flowchart showing a flow of processing of the estimation device of the present embodiment.

FIG. 10 is a block diagram showing a configuration of a learning device and an estimation device in the technology described in NPL 1.

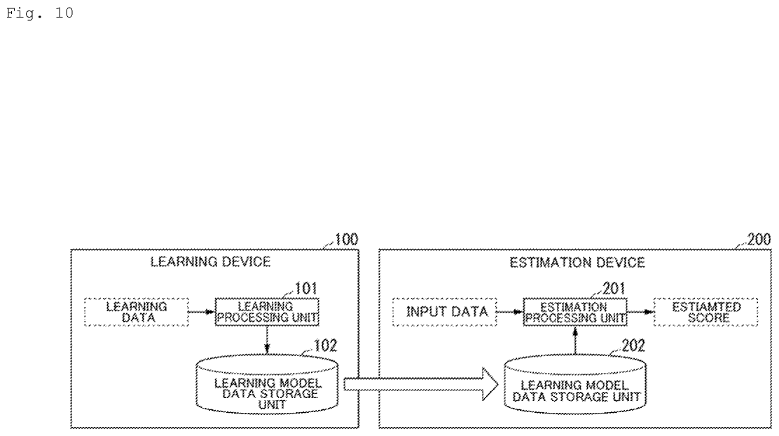

FIG. 11 is a diagram showing the overview and results of experiments performed on the technology described in NPL 1.

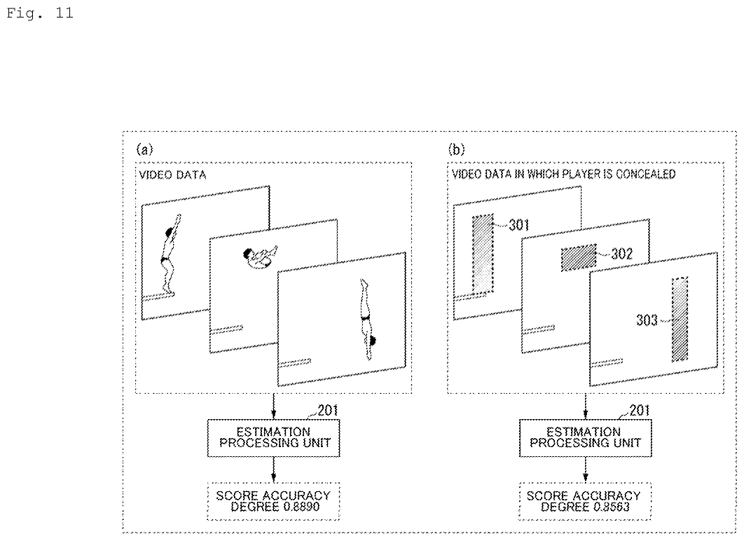

### DESCRIPTION OF EMBODIMENTS

(Configuration of Learning Device)

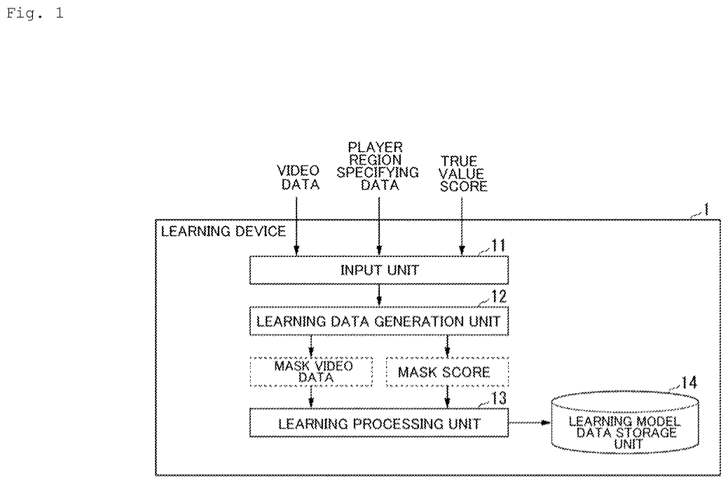

Hereinafter, embodiments of the present invention will be described with reference to the accompanying drawings. FIG. 1 is a block diagram showing a configuration of a learning device 1 according to an embodiment of the present invention. The learning device 1 includes an input unit 11, a learning data generation unit 12, a learning processing unit 13, and a learning model data storage unit 14.

The input unit 11 fetches video data in which a series of actions to be evaluated for grading among actions performed by a player is recorded along with a background. For example, if the player is a high dive athlete, actions of the player standing on a diving platform, jumping, performing actions such as twisting and spinning, and entering a pool are recorded in the video data. The input unit 11 fetches player region specifying data indicating a position of a region surrounding a region where the player is displayed in a rectangular shape in each of a plurality of image frames included in each piece of the video data.

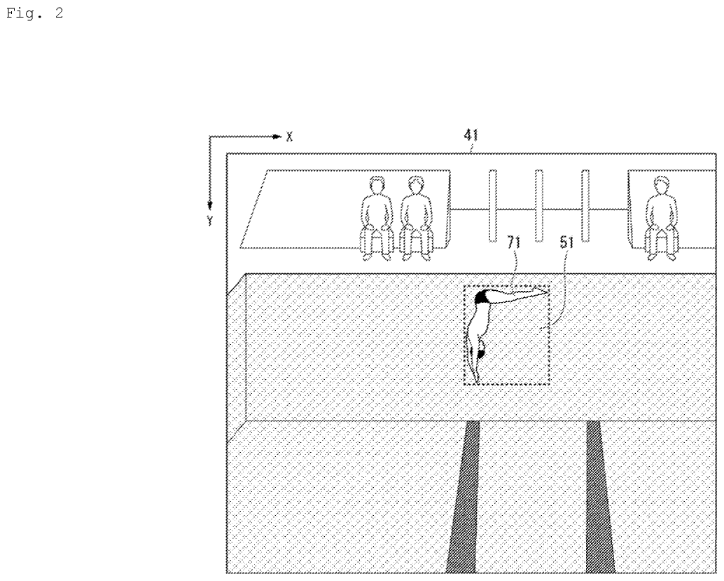

For example, FIG. 2 is a diagram showing one image frame 41 included in video data in which a diving game is recorded, and a rectangular region 51 represented by a dotted line surrounding an entire image 71 of a player is a region indicated by player region specifying data. The player region specifying data is data including XY coordinates of four vertexes of the rectangular shape when the position of each pixel of the image frame 41 is represented by XY coordinates with the upper left corner as the origin, for example.

The player region specifying data may be automatically generated from each of the image frames included in the video data by technology shown in the following reference literature, or may be manually generated while visually confirming all the image frames included in the video data.

[Reference Literature: Kaiming He, Georgia Gkioxaria, Piotr Dollar and Ross Girshick, “Mask R-CNN,” in ICCV, 2017]

The input unit 11 fetches a true value score which is an evaluation value for the actions of the player recorded in the video data. The true value score is, for example, a score actually graded by a referee when the video data is recorded for the actions of the player recorded in the video data.

Since the input unit 11 fetches a plurality of pieces of video data, the input unit 11 fetches a plurality of pieces of player region specifying data for each image frame included in the video data and one true value score for each piece of video data. The true value score is associated with the video data, and each of the plurality of pieces of player region specifying data is associated with one of the plurality of image frames included in the video data.

The learning data generation unit 12 generates mask video data obtained by arbitrarily masking a part of a region indicated by player region specifying data corresponding to each of the plurality of image frames included in the video data on the basis of the video data output by the input unit 11 and the player region specifying data corresponding to the video data. The learning data generation unit 12 generates a mask score obtained by weighting a true value score corresponding to the video data output by the input unit 11 depending on a ratio of the masked region for each piece of video data.

The learning processing unit 13 generates learning model data indicating a relationship between the mask video data and a mask score corresponding to the mask video data. More specifically, the learning processing unit 13 has the function approximater, reads coefficients of the function approximater stored in the learning model data storage unit 14, and applies the read coefficients to the function approximater. The learning processing unit 13 updates the coefficients of the function approximater by performing learning processing such that an estimated score obtained as an output value by providing the mask video data to the function approximater approaches a mask score corresponding to the mask video data. Here, the function approximater is, for example, a DNN. A coefficient is a weight or a bias applied to each of a plurality of neurons included in the DNN.

The learning model data storage unit 14 preliminarily stores initial values of the coefficients applied to the function approximater of the learning processing unit 13 in an initial state. Each time the learning processing unit 13 calculates new coefficients through learning processing, the coefficients stored in the learning model data storage unit 14 are rewritten into new coefficients by the learning processing unit 13.

(Processing Performed by Learning Data Generation Unit)

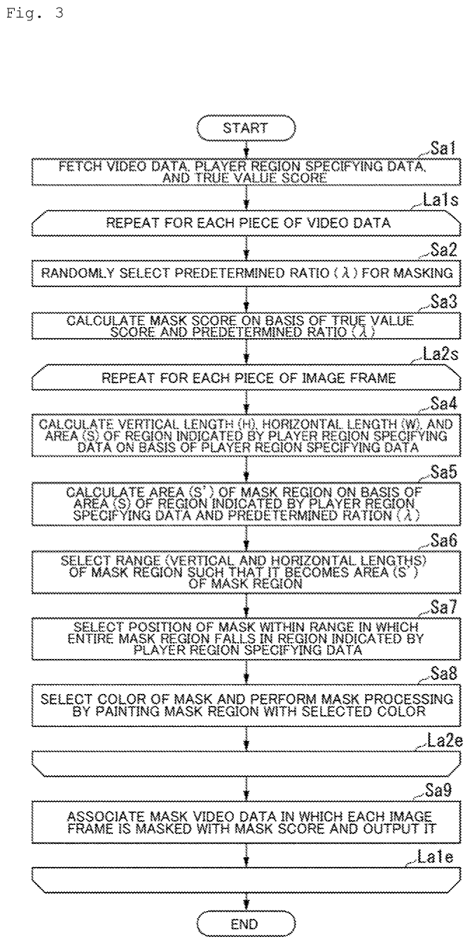

FIG. 3 is a flowchart showing a flow of processing of generating mask video data and a mask score by the learning data generation unit 12. The learning data generation unit 12 fetches a plurality of pieces of video data output by the input unit 11, and player region specifying data and a true value score corresponding to each of the plurality of pieces of video data (step Sa1).

The learning data generation unit 12 repeatedly performs processing of steps Sa2 to Sa8 on each of the plurality of pieces of video data (loops La1s to La1e). The learning data generation unit 12 randomly selects a predetermined ratio indicating a ratio of a region to be masked (hereinafter referred to as a “mask region”) from values between 0 and 1. For example, the learning data generation unit 12 selects the predetermined ratio W on the basis of a uniform distribution in which each value between 0 and 1 appears at the same probability (step Sa2).

The learning data generation unit 12 calculates a mask score on the basis of a true value score corresponding to video data that is a processing target and the selected predetermined ratio W. For example, when the true value score is t_{score} and the mask score is m_{score}, the learning data generation unit 12 calculates the mask score m_{score} using the following formula (1) (step Sa3).

m_{score}=λt_{score} (1)

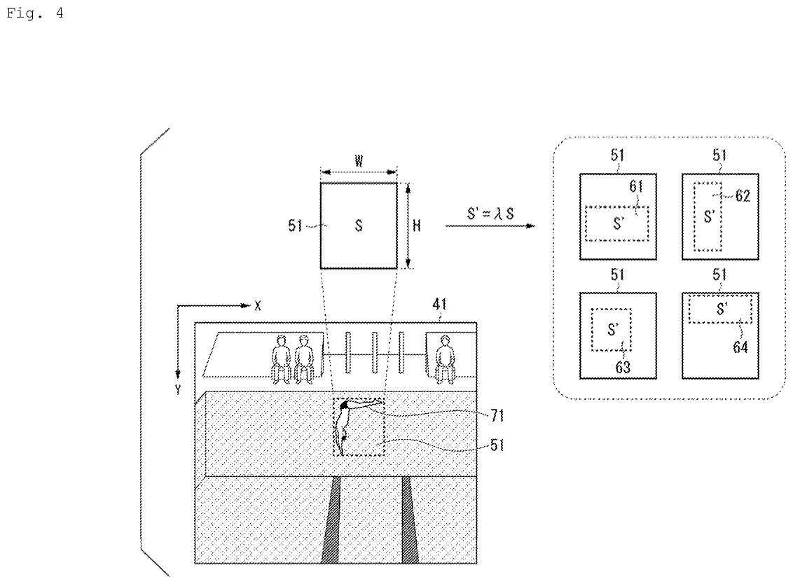

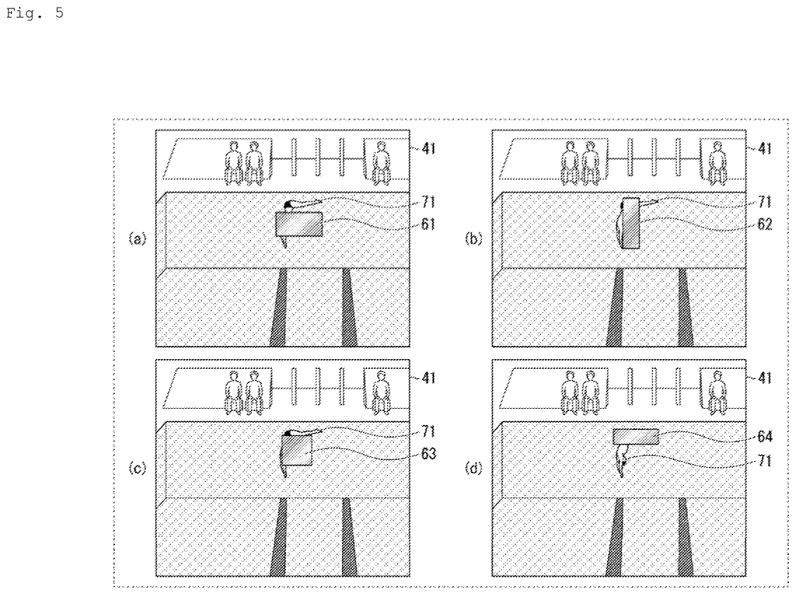

The learning data generation unit 12 repeatedly performs processing of steps Sa4 to Sa8 on each of a plurality of image frames included in the video data that is the processing target (loops La2s to La2e). Hereinafter, processing of steps Sa4 to Sa8 will be described with reference to FIG. 4 and FIG. 5.

It is assumed that the image frame 41 shown in FIG. 4 is an image frame that is a processing target of the learning data generation unit 12. The learning data generation unit 12 calculates a vertical length (H), a horizontal length (W), and an area (S) of a region 51 indicated by player region specifying data corresponding to the image frame 41 that is the processing target on the basis of XY coordinates of four vertexes included in the player region specifying data (step Sa4).

The learning data generation unit 12 calculates an area (S′) of the mask region, for example, using the following formula (2) on the basis of the predetermined ratio selected in step Sa2 and the calculated area (S) of the region 51 indicated by the player region specifying data (step Sa5).

S′=λS (2)

The learning data generation unit 12 selects a range of the mask region such that the range becomes the area (S′) of the mask region. Specifically, the learning data generation unit 12 selects a vertical length (H′) and a horizontal length (W′) of the mask region. For example, the learning data generation unit 12 randomly selects the horizontal length (W′) of the mask region from a range of the following formula (3).

S′/H≤W′≤W (3)

The learning data generation unit 12 calculates the vertical length (H′) of the mask region using the following formula (4) on the basis of the selected horizontal length (W′) and the area (S′) of the mask region.

H′=S′/W′ (4)

It is noted that, as described above, instead of selecting the horizontal length (W′) of the mask region first, the vertical length (H′) of the mask region may be selected first. In this case, for example, the learning data generation unit 12 randomly selects the vertical length (H′) of the mask region from a range of the following formula (5).

S′/W≤H′≤H (5)

The learning data generation unit 12 calculates the horizontal length (W′) of the mask region using the following formula (6) on the basis of the selected vertical length (H′) and the area (S′) of the mask region.

W′=S′/H′ (6)

The reason for selecting the length of the mask region from the range of formula (3) or formula (5) is that the range of the mask region is within the range of the region 51 indicated by the player region specifying data. At the time of randomly selecting the horizontal length (W′) from the range of formula (3) and at the time of randomly selecting the vertical length (H′) from the range of formula (5), for example, the learning data generation unit 12 randomly selects the lengths on the basis of a uniform distribution (step Sa6).

The learning data generation unit 12 randomly selects the position of the mask region within a range in which the entire mask region is within the region 51 indicated by the player region specifying data in consideration of the vertical length (H′) and the horizontal length (W′) of the mask region.

It is assumed that the position of each pixel of the image frame 41 is represented by XY coordinates with the upper left corner as the origin, for example, the right direction is a direction in which the X coordinate increases, and the downward direction is a direction in which the Y coordinate increases. It is assumed that the upper left coordinates of the region 51 indicated by the player region specifying data are (X₁, Y₁). In this case, the learning data generation unit 12 randomly selects, for example, the X coordinate at the upper left of the mask region from a range of X₁ to X₁+(W−W′) on the basis of a uniform distribution, and randomly selects the Y coordinate at the upper left of the mask region from a range of Y₁ to Y₁+(H−H′) on the basis of a uniform distribution (step Sa7).

FIG. 4 shows an example of four mask regions 61, 62, 63, and 64 randomly selected with respect to the region 51 indicated by the player region specifying data in one image frame 41. Since the learning data generation unit 12 randomly selects one mask region with respect to one image frame, any one of the mask regions 61, 62, 63, and 64 is selected as the mask region of the image frame 41. As shown in FIG. 4, all of the four mask regions 61, 62, 63, and 64 are disposed at positions within the range of the region 51 indicated by the player region specifying data.

The learning data generation unit 12 selects a color for painting the mask region. For example, the learning data generation unit 12 selects an average color of the image frame that is the processing target as a color for painting the mask region. The learning data generation unit 12 performs mask processing by painting the range of the mask region of the image frame that is the processing target with the selected color (step Sa7).

FIG. 5(a) to (d) show examples in which the mask regions 61, 62, 63, and 64 shown in FIG. 4 are applied to the image frame 41 and the ranges of the mask regions 61, 62, 63, and 64 are painted with the average color of the image frame 41. Accordingly, a part of the region 51 indicated by the player region specifying data in the image frame 41 is arbitrarily masked.

The learning data generation unit 12 generates mask video data in which mask processing has been performed on all image frames of the video data that is the processing target by performing processing of steps Sa4 to Sa8 on each of the image frames included in the video data that is the processing target (loop La2e). The learning data generation unit 12 associates the mask score m_{score} calculated in step Sa3 with the generated mask video data and outputs it to the learning processing unit 13 (step Sa9).

For example, when the plurality of image frames included in the mask video data generated by the learning data generation unit 12 are displayed from the beginning in a time series order, the entire image of the player may be seen depending on the range or position of the mask region, a part of the image of the player is displayed in a state of being randomly concealed by the mask.

The learning data generation unit 12 repeatedly performs processing of steps Sa2 to Sa8 on all video data (loop Late). Accordingly, the learning data generation unit 12 can generate a plurality of pieces of mask video data and a plurality of mask scores m_{score} associated with the respective pieces of mask video data as learning data to be used for the learning processing unit 13 for learning processing on the basis of the plurality of pieces of video data, player region specifying data corresponding to each of the plurality of pieces of video data, and the true value score.

Although the learning data generation unit 12 selects the predetermined ratio from values between 0 and 1 on the basis of a uniform distribution in step Sa2, the predetermined ratio may be selected on the basis of a distribution other than the uniform distribution. For example, the learning data generation unit 12 may randomly select any one of limited five values such as 0.0, 0.25, 0.5, 0.75, and 1.0 as the predetermined ratio (2′), or may set a value randomly selected from a plurality of fixed values specified by dividing the range in which the ratio is selected, that is, the range of 0 to 1, by an arbitrary step width other than 0.25 as the predetermined ratio W.

Although the learning data generation unit 12 randomly selects the horizontal length (W′) or the vertical length (H′) of the mask region on the basis of the uniform distribution in step Sa6, it may be randomly selected on the basis of a distribution other than the uniform distribution. Similarly to selection of the predetermined ratio (2′), a value randomly selected from a plurality of fixed values specified by dividing a selected range by an arbitrary step width may be set as the horizontal length (W′) or the vertical length (H′).

Although the learning data generation unit 12 randomly selects the position of the mask region on the basis of the uniform distribution in step Sa7, it may be randomly selected on the basis of a distribution other than the uniform distribution. Similarly to selection of the predetermined ratio (2′), a value randomly selected from a plurality of fixed values specified by dividing a selected range by an arbitrary step width may be set as the position of the mask region.

Although the learning data generation unit 12 calculates the mask score m_{score} using formula (1) in step Sa3, the learning data generation unit 12 may calculate the mask score m_{score} from the true value score t_{score} by applying 2, to a variable parameter of another function, for example, sigmoid function or the like.

Although the learning data generation unit 12 selects the average color of the image frame that is the processing target as a color for painting the mask region corresponding to the image frame in step Sa8, the configuration of the present invention is not limited to this embodiment. The learning data generation unit 12 may select an average color of all image frames included in the video data that is the processing target as a color for painting all mask regions corresponding to the video data. The learning data generation unit 12 may perform mask processing by painting all mask regions with the same color using an arbitrarily determined color. Since it is desirable that the color of the mask region be inconspicuous, it is necessary to select an inconspicuous color according to the entire color tone for each image frame, and in view of this, it is considered that it is most effective to select an average color for each image frame which is dissolved in the background and has an inconspicuous color tone.

(Processing Performed by Learning Processing Unit)

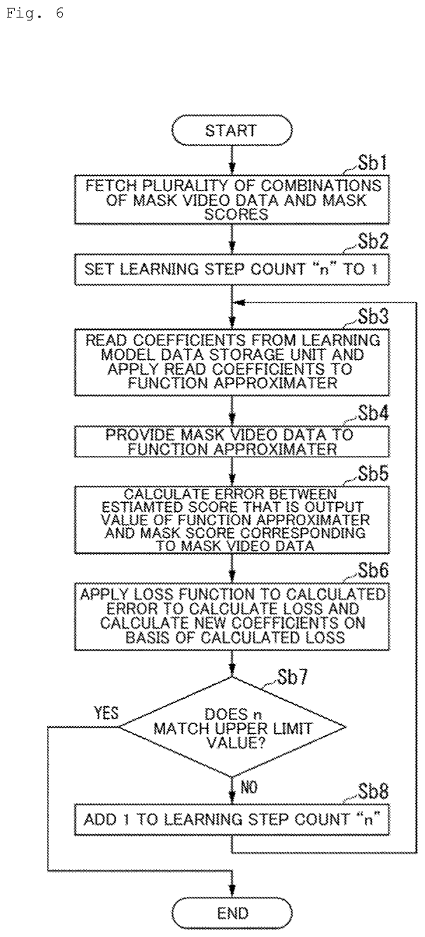

FIG. 6 is a flowchart showing a flow of learning processing performed by the learning processing unit 13. The learning processing unit 13 preliminarily stores an upper limit value of the number of learning steps required for the coefficients of the function approximater included therein to sufficiently converge in an internal storage area. The learning model data storage unit 14 preliminarily stores initial values of coefficients applied to the function approximater included in the learning processing unit 13.

The learning processing unit 13 fetches a plurality of pieces of mask video data output by the learning data generation unit 12 and a plurality of mask scores m_{score} associated with the respective pieces of mask video data. The learning processing unit 13 provides a number indicating the order of processing to each of combinations of the plurality of pieces of fetched mask video data and the plurality of mask scores m_{score}, writes the number in the internal storage area, and stores the number (step Sb1). The learning processing unit 13 generates a region in which a variable n indicating the number of learning steps (hereinafter referred to as “learning step count n”) is stored in the internal storage area, and writes “1” in the generated region (step Sb2).

The learning processing unit 13 reads coefficients stored in the learning model data storage unit 14 and applies the read coefficients to the function approximater (step Sb3). The learning processing unit 13 reads mask video data and a mask score m_{score} in the first processing order from the internal storage area. The learning processing unit 13 provides the read mask video data to the function approximater as input data (step Sb4).

The learning processing unit 13 calculates an error between an estimated score (hereinafter referred to as an “estimated score y_{score}”) which is an output value of the function approximater and the mask score m_{score} read in step Sb4 (step Sb5). The learning processing unit 13 calculates a loss by applying a loss function to the calculated error. The learning processing unit 13 calculates new coefficients of the function approximater through a method such as the error inverse propagation method such that the calculated loss is reduced. The learning processing unit 13 writes the calculated new coefficients in the learning model data storage unit 14 to update the coefficients (step Sb6).

As the loss function, a function for calculating an estimated score y_{score} and an L1 distance (Manhattan distance) of a mask score m_{score} may be used, a function for calculating an estimated score y_{score} and an L2 distance (Euclid distance) of a mask score m_{score} may be used, or a function for calculating the sum of the L1 distance and the L2 distance may be used.

The learning processing unit 13 reads the learning step count n from the internal storage area and determines whether the read learning step count n matches the upper limit value stored in the internal storage area (step Sb7). If it is determined that the read learning step count n does not match the upper limit value (No in step Sb7), the learning processing unit 13 adds 1 to the read learning step count n. The learning processing unit 13 writes a value of n+1, which is the added value, to the region of the learning step count n in the internal storage area as a new learning step count n (step Sb8) and re-performs processing of step Sb3 and subsequent steps.

In processing of subsequent step Sb3, the learning processing unit 13 reads the coefficients updated in step Sb6 from the learning model data storage unit 14 and applies the read coefficients to the function approximater. In subsequent step Sb4, the learning processing unit 13 reads mask video data and a mask score m_{score} in the subsequent processing order and provides the read mask video data to the function approximater. When the learning processing unit 13 has performed processing of steps Sb4 to Sb6 on combinations of all pieces of mask video data and mask scores m_{score} while processing of steps Sb3 to Sb6 is repeatedly performed, the learning processing unit 13 returns the order to the first one, sequentially reads mask video data and mask scores from a combination of the mask video data and the mask score m_{score} in the first processing order, and performs processing of steps Sb4 to Sb6.

On the other hand, if it is determined that the read learning step count n matches the upper limit value (Yes in step Sb7), the learning processing unit 13 ends processing. Accordingly, trained coefficients that have sufficiently converged are stored in the learning model data storage unit 14, and these trained coefficients become learning model data indicating a trained learning model.

Although FIG. 6 shows a method of online learning for updating the coefficients of the function approximater for each combination of mask video data and a mask score m_{score}, mini-batch learning for updating the coefficients of the function approximater may be performed for each combination of a predetermined number of pieces of mask video data and mask scores m_{score}, or batch learning for updating the coefficients of the function approximater may be performed for each combinations of all pieces of mask video data and mask score M_{score}.

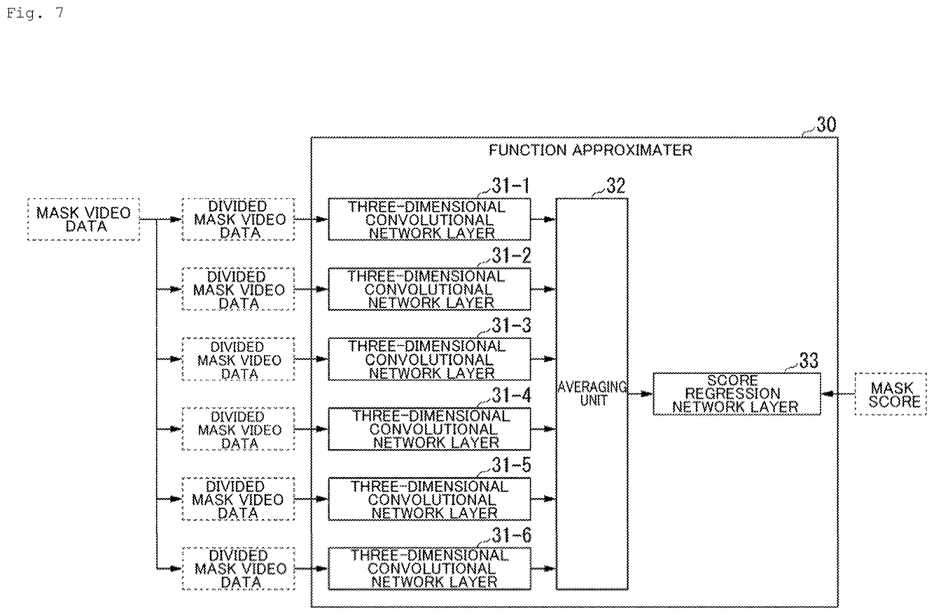

FIG. 7 is a diagram showing a configuration of a DNN in a function approximater 30 which is an example of the function approximater included in the learning processing unit 13. When the learning processing unit 13 fetches mask video data, for example, the learning processing unit 13 resamples the mask video data into 96 frames and divides the 96 frames by 16 to generate 6 pieces of divided mask video data. The function approximater 30 includes three-dimensional convolution network layers 31-1 to 31-6, an averaging unit 32, and a score regression network layer 33. Each of the three-dimensional convolution network layers 31-1 to 31-6 fetches each of the 6 pieces of divided mask video data. Each of the three-dimensional convolution network layers 31-1 to 31-6 performs feature extraction from the divided mask video data fetched thereby and outputs a feature amount of the divided mask video data fetched thereby.

The averaging unit 32 averages and outputs feature amounts of the divided mask video data output by the three-dimensional convolution network layers 31-1 to 31-6. The score regression network layer 33 performs regression analysis on the basis of the average of the feature amounts of the divided mask video data output by the averaging unit 32 and mask scores m_{score} corresponding to the mask video data and extracts a relationship between the average of the feature amounts of the divided mask video data and the mask scores m_{score}. Learning processing is repeatedly performed by the learning processing unit 13, and thus the accuracy of feature extraction performed by the three-dimensional convolution network layers 31-1 to 31-6 and regression analysis performed by the score regression network layer 33 is enhanced. Coefficients stored in the learning model data storage unit 14 are applied to the three-dimensional convolution network layers 31-1 to 31-6 and the score regression network layer 33. A common coefficient, that is, the same coefficient, is applied to each of the three-dimensional convolution network layers 31-1 to 31-6.

(Configuration of Estimation Device)

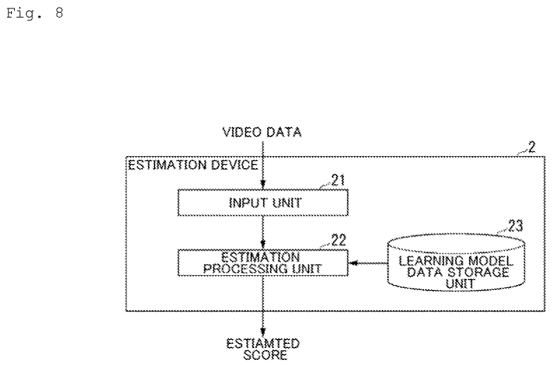

FIG. 8 is a block diagram showing a configuration of the estimation device 2 according to an embodiment of the present invention. The estimation device 2 includes an input unit 21, an estimation processing unit 22, and a learning model data storage unit 23. The learning model data storage unit 23 preliminarily stores trained coefficients stored in the learning model data storage unit 14 of the learning device 1, that is, trained learning model data. The input unit 21 fetches arbitrary video data, that is, video data in which a series of actions performed by an arbitrary player are recorded along with a background.

The estimation processing unit 22 calculates an estimated score corresponding to the video data on the basis of the arbitrary video data fetched by the input unit 21 and the trained learning model data stored in the learning model data storage unit 23. The estimation processing unit 22 includes a function approximater having the same configuration as that of the learning processing unit 13.

(Processing of Estimation Device)

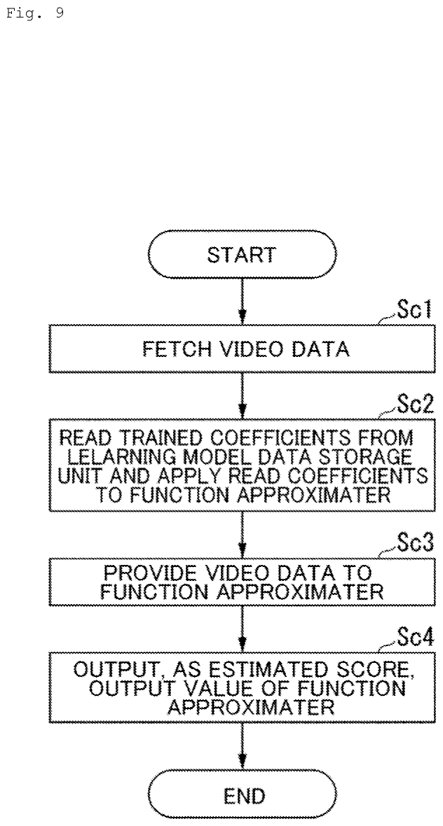

FIG. 9 is a flowchart showing a flow of processing performed by the estimation device 2. The input unit 21 fetches arbitrary video data and outputs the fetched video data to the estimation processing unit 22 (step Sc1). The estimation processing unit 22 fetches the video data output by the input unit 21. The estimation processing unit 22 reads trained learning model data, that is, trained coefficients, from the learning model data storage unit 23 and applies the read trained coefficients to the function approximater (step Sc2).

The estimation processing unit 22 provides the fetched video data to the function approximater as input data (step Sc3). The estimation processing unit 22 outputs an output value of the function approximater as an estimated score for the video data (step Sc4).

In the learning device 1 of the above-described embodiment, the input unit 11 fetches video data, player region specifying data for specifying a region surrounding a player in each of a plurality of image frames included in the video data, and a true value score which is an evaluation value for a game of the player recorded in the video data. The learning data generation unit 12 generates mask video data by masking a region of a part of an arbitrary position of a region indicated by player region specifying data corresponding to each image frame, which has a size of a predetermined ratio arbitrarily determined for each piece of video data, and generates a mask score by weighting a true value score for each piece of video data according to a predetermined ratio corresponding to the video data in each of a plurality of image frames included in the video data. The learning processing unit 13 generates learning model data indicating a relationship between mask video data corresponding to the video data and a mask score corresponding to the video data. Accordingly, in some of a plurality of image frames included in the mask video data generated by the learning data generation unit 12, a part of the image of the player is randomly concealed by the mask. Therefore, in learning processing performed by the learning processing unit 13, extraction of features in video data related to actions of the player is promoted. Accordingly, it is possible to generate learning model data generalizing actions of the player from video data in which the actions of the player are recorded, as shown by the above-described experimental results, without explicitly providing information difficult to estimate, such as joint information.

Although the above embodiment shows an example in which one player is included in the region indicated by the player region specifying data, a plurality of players may be included in the region indicated by the player region specifying data.

Although the shape of the region indicated by the player region specifying data is rectangular in the above embodiment, the shape is not limited to the rectangular shape and may be shapes other than the rectangular shape.

Although a true value score is a score actually graded by a referee in the above embodiment, it may be a score graded by a standard other than a quantitative grading standard adopted in actual games.

Although the function approximater included in the learning processing unit 13 of the learning device 1 and the estimation processing unit 22 of the estimation device 2 of the above embodiment is, for example, a DNN, and has the configuration shown in FIG. 7 as an example, a neural network other than the DNN or a means by machine learning may be applied.

The learning device 1 and the estimation device 2 may be integrated. In such a configuration, a device in which the learning device 1 and the estimation device 2 are integrated has a learning mode and an estimation mode. The learning mode is a mode for generating a trained learning model by performing learning processing by the learning device 1. That is, in the learning mode, the device in which the learning device 1 and the estimation device 2 are integrated executes processing shown in FIG. 6. The estimation mode is a mode for outputting an estimated score using a trained model. That is, in the estimation mode, the device in which the learning device 1 and the estimation device 2 are integrated executes processing shown in FIG. 9.

The learning device 1 and the estimation device 2 in the above-described embodiment may be realized by a computer. In such a case, a program for realizing their functions may be recorded on a computer-readable recording medium, and the program recorded on the recording medium may be read and executed by a computer system. It is assumed that the “computer system” as used herein includes an OS and hardware such as peripheral devices. In addition, the “computer-readable recording medium” refers to a portable medium such as a flexible disk, a magneto-optical disk, a ROM, or a CD-ROM, or a storage apparatus such as a hard disk that is built into the computer system. Furthermore, the “computer-readable recording medium” may also include a recording medium that dynamically holds a program for a short period of time such as a communication line when the program is to be transmitted via a network such as the Internet or a communication line such as a telephone line, as well as a recording medium that holds a program for a certain period of time such as a volatile memory inside a server or a computer system serving as a client. Moreover, the program described above may be any of a program for realizing some of the functions described above, a program capable of realizing the foregoing functions in combination with a program already recorded in a computer system, and a program for realizing the functions using a programmable logic device such as an FPGA (Field Programmable Gate Array).

Although the embodiments of the present invention have been described in detail with reference to the drawings, specific configurations are not limited to these embodiments, and designs and the like within a range that does not deviating from the gist of the present invention are also included.

### INDUSTRIAL APPLICABILITY

The present invention can be used to score a game in sports games.

### REFERENCE SIGNS LIST

1 Learning device
11 Input unit
12 Learning data generation unit
13 Learning processing unit
14 Learning model data storage unit

1. A learning device comprising a learning processing unit configured to generate learning model data indicating a relationship between mask video data obtained by arbitrarily masking a part of a region surrounding a player in each of a plurality of image frames included in video data in which actions of the player are recorded, and a mask score obtained by weighting a true value score which is an evaluation value for a game of the player recorded in the video data according to a ratio of the masked region.

2. The learning device according to claim 1, wherein the learning processing unit includes a function approximater, and updates the learning model data which is coefficients of the function approximater by performing learning processing such that an estimated score obtained as an output value by providing the mask video data to the function approximater approaches the mask score corresponding to the mask video data.

3. The learning device according to claim 1 or 2, comprising: an input unit configured to fetch the video data, player region specifying data that specifies a region surrounding the player in each of a plurality of image frames included in the video data, and the true value score corresponding to the video data; and
a learning data generation unit configured to generate the mask video data by masking a region of a part of an arbitrary position of a region indicated by the player region specifying data corresponding to each of the image frames, which has a size of a predetermined ratio arbitrarily determined for each piece of the video data, and to generate the mask score by weighting the true value score for each piece of the video data according to the predetermined ratio corresponding to the video data in each of the plurality of image frames included in the video data.

4. The learning device according to claim 3, wherein the learning data generation unit paints a mask region corresponding to the image frame with an average color of the image frame to mask the mask region, paints all mask regions corresponding to the video data with an average color of the video data to mask the mask regions, or paints all mask regions with an arbitrarily determined identical color to mask the mask regions.

5. An estimation device comprising: an input unit configured to fetch video data in which actions of a player are recorded; and
an estimation processing unit configured to calculate an estimated score corresponding to the video data on the basis of learning model data indicating a relationship between mask video data obtained by arbitrarily masking a part of a region surrounding the player in each of a plurality of image frames included in the video data in which actions of the player are recorded and a mask score obtained by weighting a true value score which is an evaluation value for a game of the player recorded in the video data according to a ratio of the masked region, and the video data.

6. A learning method comprising generating learning model data indicating a relationship between mask video data obtained by arbitrarily masking a part of a region surrounding a player in each of a plurality of image frames included in video data in which actions of the player are recorded, and a mask score obtained by weighting a true value score which is an evaluation value for a game of the player recorded in the video data according to a ratio of the masked region.

7. (canceled)
